(19) United States
(12) Patent Application Publication
(10) Pub. No.: US 2002/0117849 A1
(43) Pub. Date: Aug. 29, 2002

(54) Swivel connector for dental and medical handpieces

(75) Inventor: Ronald L. Bailey, Harvester, MO (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: Young Dental Manufacturing Company

(21) Appl. No.: 09/873,593

(22) Filed: Jun. 4, 2001

Related U.S. Application Data
(60) Provisional application No. 60/272,513, filed on Feb. 26, 2001.

(51) Int. Cl. F16L 3/00

(52) U.S. Cl. 285/123.15

(57) ABSTRACT

A connector is provided to connect a medical/dental instrument to a supply hose carrying air, water, and light from a control unit. The connector includes a first portion which is rotatably received in a second portion. The first portion includes a body and a nose extending from the body. The connector includes air and water passages and a light tube passage which are operably connectable to the sources of air, water, and light through a supply hose. The nose has a generally smooth uninterrupted surface. The operating air and water passages exit on the side of the nose, and the light tube passage and chip air passage exit at the end of the nose. The connector first portion can be used by itself to support an instrument which, for example, need only the light, or in association with the second portion.

The connector second portion is located in the back of a tool body. The connector second portion includes a central passage way having inner annular channels which are positioned to be in communication with the air and water exits of the connector first portion. The connector second portion also has a central opening through which the light tube extends to deliver light to the front of the tool. The connector second portion includes three internal O-rings to isolate the annular channels from each other when the first portion is received in the second portion.

### CROSS-REFERENCE TO RELATED APPLICATIONS

This application claims priority to provisional application Ser. No. 60/272,513, entitled “Swivel Connector For Dental And Medical Handpieces” filed Feb. 23, 2001, and which is incorporated herein by reference.

### STATEMENT REGARDING FEDERALLY SPONSORED RESEARCH OR DEVELOPMENT

Not Applicable

### BACKGROUND OF THE INVENTION

This invention relates to connectors for connecting dental or medical tools which require light, air, and/or water for their operation, and in particular, to a swivel connector which is used to connect the dental or medical tool to a supply hose of a control unit havin a standard connector at its end.

Dental and medical tools include items such as drills, optical instruments, washing instruments, etc. Such tools rely on air, water, and/or light for their operation. Oftentimes, the tool will have two or even all three of air, water and light. The tools which use light generally include fiber optics to carry the light through the tool to deliver the light to the work area. There may also be various exhaust paths to exhaust drive air from the tool. The operating air, chip air, water, and light, as well as the exhaust paths, are often contained in a supply hose which extends from a control unit. The tool is connected to the supply hose by a connector on the end of the hose. Typically, the tool has a back end which is adapted to mate with the supply hose connector. Such supply hose connectors are generally standardized, and are well known in the art. A standard connector is sold by Midwest Dental Products Corporation of Des Plaines, Ill., and is shown in ISO 9168, which is incorporated herein by reference.

The supply hose connection to the tool is a static connection. That is, the tool cannot be swiveled relative to the supply hose. However, during use of the tool, the practitioner (dentist, hygienist, technician, doctor, etc.) will often rotate the tool to reach a desired spot on the patient. Such rotating or pivoting of the tool about its axis can cause the supply hose to become twisted. To prevent twisting of the supply hose, a swivel connector can be interposed between the supply hose and the tool. The swivel connector allows the tool to be rotated about its axis without fear of twisting the supply hose which extends from the control unit.

Swivel connectors include a back end which is connected to the supply hose connector and a front end which is received in the back end of the tool. The swivel connector typically includes paths for water, air, exhaust, and light. The inlets to these paths are aligned with the appropriate output from the supply hose connector and their outlets are aligned with appropriate passages in the back of the tool. Thus, air, water, light, and exhaust will be delivered to the output of the tool to allow for proper operation of the tool. The currently available swivel connectors are complex in design and construction. They include O-rings on their outer surfaces, which, in some commercially available swivel connectors, are of different diameters and widths. This use of the O-rings on the outer surfaces of the swivel connectors prevents the swivel connector from having a smooth, uninterrupted surface. Thus, the swivel connectors are difficult to clean. Further, if the connector is to be used to mount multiple instruments to the hose, the O-rings on the outer surface of the connector will wear quickly and need to be replaced more often.

Additionally, the available connectors generally do not include the complete light tube (i.e., fiber optic bundle) which is used to transmit light to the end of the tool. Rather, the tool itself includes a light tube which carries the light from the back of the tool to the head of the tool. Thus, the connector makes a light connection with the light tube inside of the tool in order for light to be transmitted to the head of the tool. Because the tool, rather than the connector, has the light tube, the light tube in the tool is not easily replaceable, and the connector cannot be easily adapted for additional uses which can benefit from the availability of light. Further, because there are two light connections—one between the swivel connector and the supply hose connector, and one between the swivel connector and the tool—some light energy is lost at each connection. Thus, there is a reduction in the amount of light that could otherwise be transmitted to the head.

### BRIEF SUMMARY OF THE INVENTION

Briefly stated, a swivel connector is provided to operatively connect dental or medial tools which require air, water, and/or light for their operation to sources of air, water, and light. A control unit can be disposed between the tool and the sources to control the use of the air, and water, for example, with the use of a foot pedal. The swivel connector includes a first portion which is connected to the supply hose and a second portion which is fixed in the back of the tool. The first portion is received in the second portion to operatively connect the tool to the supply hose. The interconnection of the first and second portions allows for the second portion, and hence the tool, to be rotated relative to the first portion, and hence the supply hose to which the first portion is mounted.

The connector second portion includes a central passage therethrough, first and second annular channels formed in the central passage, and first and second axial passages in fluid communication with the first and second annular channels, respectively. The first and second axial passages extend to a forward surface of the connector second portion. The central passage has a central outlet sized to admit a light tube to pass therethrough. A chamber is formed between the annular passage and the outlet when the first portion is inserted in the second portion. A chip air passage extends from the chamber forwardly through the connector second portion to exit at the front of the second portion.

The connector first portion includes a connector body and a nose extending forwardly from the connector body. The nose is sized to be received in the central passage of the connector second portion. The body includes a housing defining a chamber and an insert which is received in the chamber. The nose extends from the front end of the housing. The connector body chamber includes a front wall having entrances to an air passage, a water passage, and a chip air passage which extend through the nose. The air and water passages exit along the side of the nose and the chip air passage exits at the end of the nose. The connector insert includes air, water, and chip air passages which have entrances at the back of the insert positioned to be aligned with the respective exits in a standard supply hose connector, and exits positioned to be aligned with the respective passages through the nose. A light tube passage extends through both the body insert and the nose. Preferably, the light tube passage in the insert has an entrance that is offset from the center of the insert, and an exit which is generally centered with respect to the insert. The light tube passage through the nose extends generally straight through the nose.

The nose has a generally smooth uninterrupted surface. The air and water exits are positioned on the side of the nose to be in alignment with the annular channels of the connector second portion when the first and second portions are assembled together. The light tube extends through the connector body light tube passage, the nose central passage, and the connector second portion central passage exit.

A hollow guide tube extends from an end of the nose. The guide tube is axially aligned with the nose central passage, and is sized to pass through (and beyond) the exit of the connector second portion. The light tube passes through (and preferably beyond the end of) the guide tube.

As noted, the nose of the connector first portion is smooth. To seal the different passages from each other, the connector second portion includes O-rings received in O-ring channels between, and on either side of, the annular channels. When the connector first portion is inserted in the connector second portion, the nose of the first portion will seal against the O-rings in the second portion.

The connector first portion can be used in association with the second portion for tools which require any or all of air, chip air, water, and light. However, if a tool (such as a lighted mirror or a light probe) only requires light for its use, the tool, which would not include the connector second portion) can be mounted directly to the first portion.

### BRIEF DESCRIPTION OF THE SEVERAL VIEWS OF THE DRAWINGS

FIG. 1 is a block diagram showing a tool connected to a control unit via a swivel connector of the present invention;

FIG. 2 is a perspective view of a first portion of the swivel connector which is adapted to be connected to the end of the supply hose;

FIG. 3 is an exploded cross-sectional view of the swivel connector, including the first and second portions of the swivel connector;

FIG. 4 is a cross-sectional view of the swivel connector when assembled, the second portion of the swivel connector being shown positioned in a tool;

FIG. 5 is a side elevational view of a housing of the first portion of the connector;

FIG. 6 is a side elevational view, partly cut away, of the housing of the swivel connector first portion;

FIG. 7 is a back elevational view of the housing of the swivel connector first portion;

FIG. 8 is a front elevational view of the housing of the swivel connector first portion;

FIG. 9 is a side elevational view of an insert which is received within the housing of the swivel connector first portion;

FIG. 10 is a back elevational view of the housing insert;

FIG. 11 is a front elevational view of the housing insert;

FIG. 12 is cross-sectional view of the housing insert taken along line 12-12 of FIG. 10;

FIG. 13 is cross-sectional view of the housing insert taken along line 13-13 of FIG. 10;

FIG. 14 is cross-sectional view of the housing insert taken along line 14-14 of FIG. 10;

FIG. 15 is a cross-sectional view of the second portion of the swivel connector which is inserted in the tool;

FIG. 16 is a front elevational view of the second portion of the swivel connector;

FIG. 17 is a back elevational view of the second portion of the swivel connector;

FIG. 18 is a perspective view of the swivel connector first portion adapted for use as a light probe; and

FIG. 19 is a cross-sectional view of the end of the swivel connector first portion, showing the swivel connector first portion adapted for use to form a lighted dental mirror.

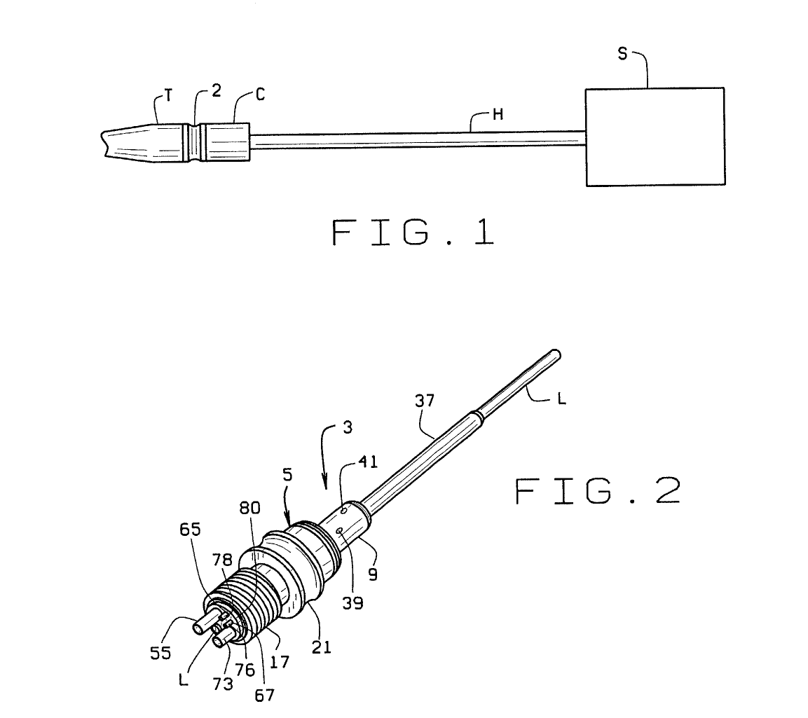

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes what I presently believe is the best mode of carrying out the invention.

As is known, certain dental and medical tools are connected to sources of air, water, and light to operate the tool, to provide irrigation in a desired area, and/or to provide lighting to a desired area. Typically, the sources of air, water, and light, are delivered from a source S to the tool by means of a supply hose H. A control unit may be disposed between the source and the instrument, the supply hose extending from the control unit. Additionally, the control unit can include the bulb (or some other source of light) which would be the source of light for the instrument. The supply hose often has an operating air line, an exhaust air line, a chip air line, a water line, and a light tube. The supply hose has its own connector C at its free end in which the water and air lines and the light tube terminate. Such supply hoses and their associated connectors are well known in the art and do not form a part of the present invention. A standard supply hose connector is shown in ISO 9168, which is incorporated herein by reference. The tool T is then mounted to the end of the supply hose by means of the supply hose connector. If the tool is mounted directly to the supply hose connector, rotation of the tool about its longitudinal axis will cause the supply hose to twist. My novel swivel connector 2 is interposed between the tool and the supply hose to enable rotation of the tool T relative to the supply hose.

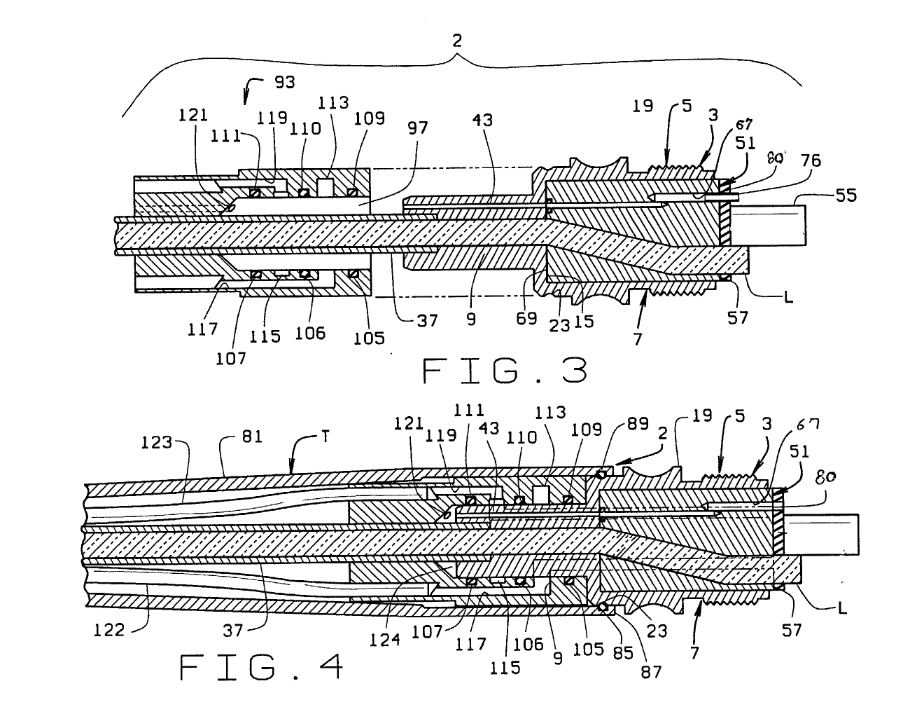

The connector 2 (FIG. 3) includes an first male portion 3 adapted to be mounted to the connector C at the end of the supply hose in any conventional manner and an second, female, portion 93 which is received in the back of the tool T. The two elements of the connector are snapped together, as will be described below to operatively connect tool T to the supply hose H and hence the control unit S.

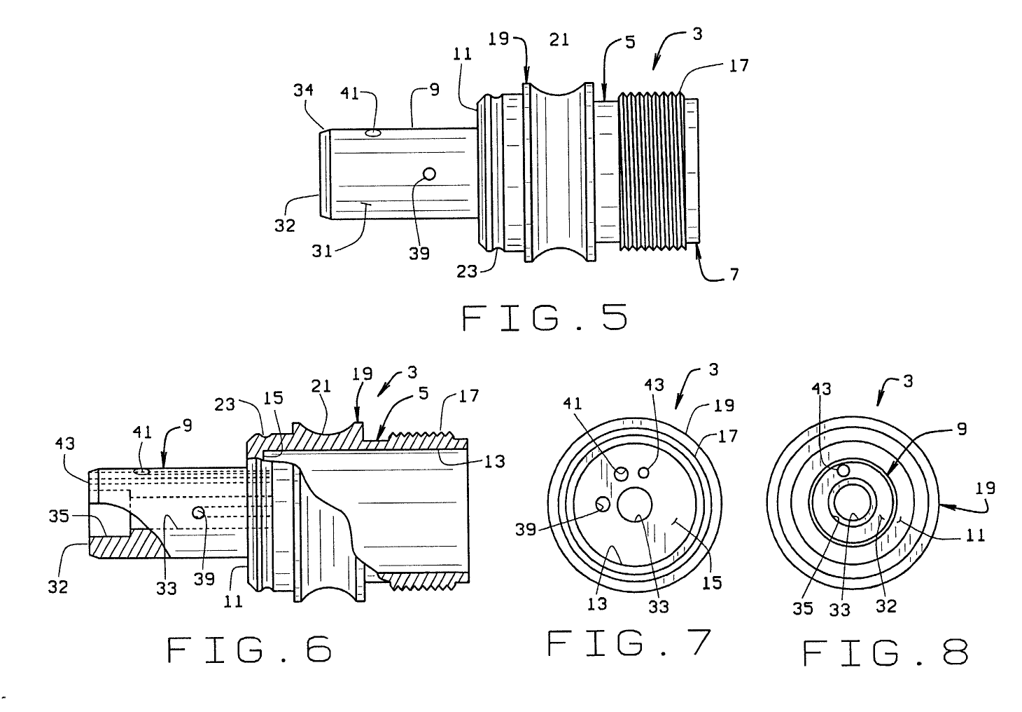

The connector first portion 3 is shown in detail in FIGS. 3 and 5-14. It includes a housing 5 (FIGS. 5-8) having a body 7 and a nose 9 extending forwardly from the front surface 11 of the body 7. The body 7 is hollow and defines a chamber 13 of generally constant inner diameter. The chamber 13 has a forward surface 15. Externally, the body 5 has threads 17 which are sized to be mated with a standard supply hose connector, as is known, to attach the connector first portion 3 to the supply hose connector C. A gripping portion 19 of increased diameter is positioned forwardly of the threads 17 and has a circumferential concave groove 21 formed on its outer surface. The gripping portion 19 enables a user to grasp the first portion 3 to insert the connector first portion 3 into, or remove the connector first portion 3 from, the connector second portion 93, as will be described below, to mount the tool T on, or disconnect the tool T from, the hose H. Lastly, slightly rearwardly of the front surface 11, the body 5 includes an external, circumferential groove 23.

The nose 9, as noted extends forwardly from the body front surface 11. The nose 9 has an outer surface 31 and a front surface 32. The end of the nose 9 is beveled slightly, as at 34. The outer surface 31 is smooth and uninterrupted. That is, it has no grooves which receive O-rings or the like. The nose 9 is hollow and defines a central passage 33 which is concentric with, but smaller in diameter than, the body chamber 13. The passage 33 is counter-bored at the front of the nose 9, as at 35, to receive a hollow guide tube 37 (FIGS. 2 and 3). Three narrower passages 39, 41, and 43 extend forwardly from the front surface 15 of the body chamber 13. The passages 39 and 41 run parallel to the nose central passage 33. However, they end short of the front of the nose, make a turn, and have axially and circumferentially spaced apart exits in the side surface 31 of the nose. The passage 43, on the other hand, extends through the wall of the nose 9 and exits the nose 9 in its front surface 32.

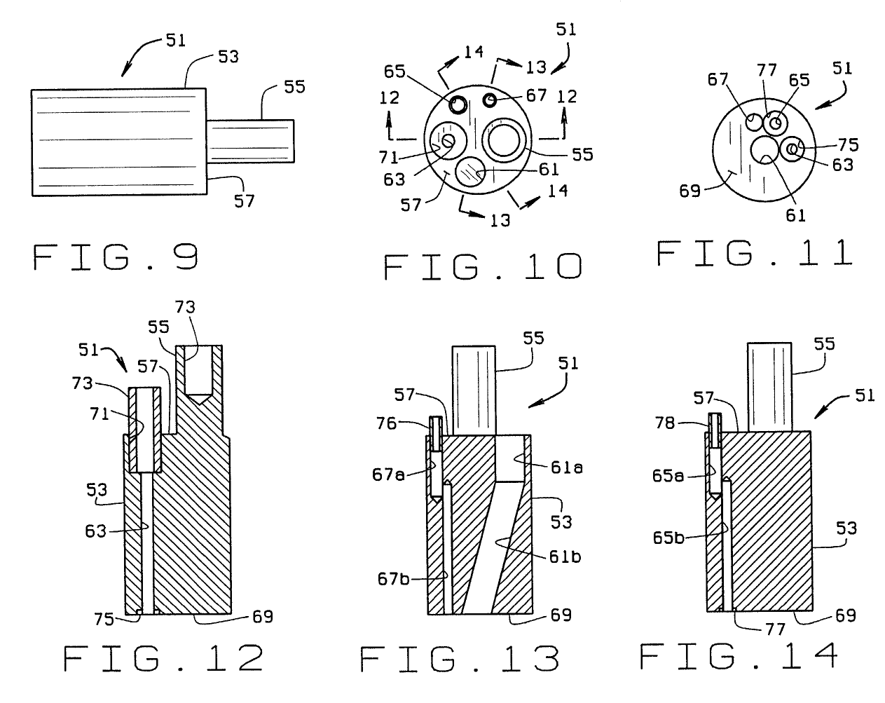

A housing insert 51 (FIGS. 9-14) is received in the chamber 13 of the connector first portion body 5. Preferably, the insert 51 is force fit into the housing chamber 13. The housing insert 51 includes an insert body 53 having a stub tube 55 extending from its back surface 57. The stub tube 55 is sized to extend into an exhaust tube of the supply hose connector. The insert body 53 has a length approximately equal to the length of the housing body chamber 13, such that when the insert body 53 is positioned in the chamber 13, the back surface 57 of the insert body 53 is substantially flush with the back surface of the housing body 5 as seen in FIGS. 3 and 4.

Four passages 61, 63, 65, and 67 pass through the body 53 from its back surface 57 to its front surface 69. The passage 61 is sized to receive a light tube L (FIG. 3). The light tube L can be a fiber optic bundle or a single rod of light transmitting material. For insertion and removal purposes, the light tube L is preferably flexible. The passage 63 is an operating air passage; the passage 65 is a water passage; and the passage 67 is a chip air passage. The four passages 61, 63, 65, and 67, along with the stub tube 55 are arranged on the back surface 57 to correspond to the standard supply hose connector interface, such that the connector part 3 can be connected to a standard supply hose connector C. The stub tube 55 is positioned to correspond to the position of an exhaust tube.

The path of the passages through the insert body 53 is shown in FIGS. 12-14. The operating air passage 63 (FIG. 12) extends straight through the body. It is counterbored at its back end, as at 71, to receive a stub tube 73, which in turn, is received in an operating air tube from the supply hose connector C. A groove 75 on the insert front surface 69 surrounds the exit of the passage 63 to receive an O-ring.

The chip air passage 67 (FIG. 13) is made in two parts. It includes a first part 67a which extends axially forwardly from the rear surface 57 of the insert body 53 and a second portion 67b which extends rearwardly from the front surface 69 of the insert body 53. The chip air passage portions 67a, b are slightly offset radially from each other and overlap each other so that they will form a complete passage through the connector insert body 53. Neither of the passages 67a nor 67b extend completely through the connector insert body 51. Preferably, the passage 67a is larger in diameter than the passage 67b. The passage 67a receives a chip air stub tube 76 which is sized to be received in a chip air outlet of the supply hose connector. Although formed as two interconnected passages, the passage 67 could be formed as one straight and continuous passage.

The light tube passage 61 (FIG. 13) includes a first portion 61a which extends generally parallel to the longitudinal axis of the insert body 53. The portion 61a is offset from the center of the insert body 53 to be closer to the surface of the insert body 53. A second portion 61b extends from the end of portion 61a and is angled such that it exits the insert body 53 substantially in the center of the body, as seen in FIGS. 11 and 13.

The water passage 65 (FIG. 14), like the chip air passage 67, is made in two parts. It includes a first part 65a which extends axially forwardly from the rear surface 69 of the body 53 and a second portion 65b which extends from the front surface 69 of the insert body 53. The water passage portions 65a, b are slightly offset radially from each other and overlap each other so that they will form a complete passage through the connector insert body 53. Neither of the passages 65a nor 65b extend completely through the connector insert body 51. The exit of passage 65 at the front surface 69 is also surrounded by a circular groove 77 to receive an O-ring. The passage 65a is larger in diameter than the passage 65b, and is sized to accept an input water stub tube 78 which is received in the water outlet of the supply hose connector. Although formed as two interconnected passages, the passage 65 could be formed as one straight and continuous passage.

As can be appreciated, the stub tube 55, the operating air sub tube 73, and the chip air and water stub tubes 76 and 78 in combination define a key, to properly align the passages in the connector portion 3 with their counterparts in the supply hose connector. As best seen in FIGS. 3 and 4, a gasket 80 is fitted over the back of the insert 51. The tubes 55, 73, 76, and 78 extend beyond the back surface of the gasket 80 to be received in their respective tubes in the supply hose. The light tube L extends only slightly beyond the end of the gasket 80. As can be appreciated, the gasket 80 forms a seal with the hose connector C when the swivel connector first portion 3 is mounted to the hose connector C.

When the insert 51 is fitted in the connector body chamber 13, the insert front surface 69 is generally in abutting relationship with the forward surface 15 of the housing chamber 13, as seen in FIGS. 3 and 4. Thus, the O-rings received in the groves 75 and 77 will form seals around the operating air and water passages. When the insert 51 is inserted in the housing body 5, the insert light tube passage 61 is aligned with the nose central passage 33; the insert chip air passage 67 is aligned with the nose body passage 43; the insert water passage 65 is aligned with the nose passage 41; and the insert air passage 63 is aligned with the nose passage 39. The light tube passage 61, the nose central passage 33, and the guide tube 37 all have a diameter slightly larger than the diameter of the light tube L so that the light tube L can be inserted into, and removed from, the connector first portion 3. That is, the light tube is held tight enough so that it is not easily accidentally displaced relative to the connector portion 3. However, it can be easily removed from the connector portion 3 for replacement.

To assemble the connector portion 3, the insert 51 is pressed fit into the housing body chamber 13 after O-rings have been inserted in grooves 75 and 77; and the gasket 80 is mounted to the back of the insert 51. The insert 51 is positioned relative to the connector housing body 5 so that the passages of the insert 51 will be aligned with their respective counterparts in the housing 5. After the guide tube 37 is fitted into the nose counterbore 35, the optic tube L is passed through the light passages of the connector portion 3. The optic tube L is sized to extend slightly beyond the back surface of the gasket 80 and to extend forwardly beyond the guide tube 37, as seen in FIGS. 2-4.

As can be appreciated, the connector portion 3, carries light, air (both operating air and chip air) and water. It can thus be used to connect many different tools which require light, air, and/or water for their operation to the supply hose, and hence to sources of light, air, and water. For example, as seen in FIGS. 18 and 19, the connector portion 3 can, as discussed below, be used by itself to connect a tool, such as an inspecting probe or a lighted mirror, to the supply S. Such tools require only the light from the control unit.

The connector portion 3 can also be mated to the connector portion 93 to complete the swivel connector 2. This will connect a tool T (such as a high speed handpiece or an air/water syringe) that requires air, water, and/or light to the control unit C, and to allow the tool T to be rotated relative to the supply hose H for ease of operation.

The tool T includes a hollow body 81 (FIG. 4) which is opened at its back end 87. An internal groove 85 set inwardly slightly from the back end 87 of the sleeve 81 receives a lock ring 89. The lock ring 89 is substantially circular in shape. However, it is flattened along a portion of its arc, such that a portion of the lock ring 89 is exposed or extends out of the groove 85.

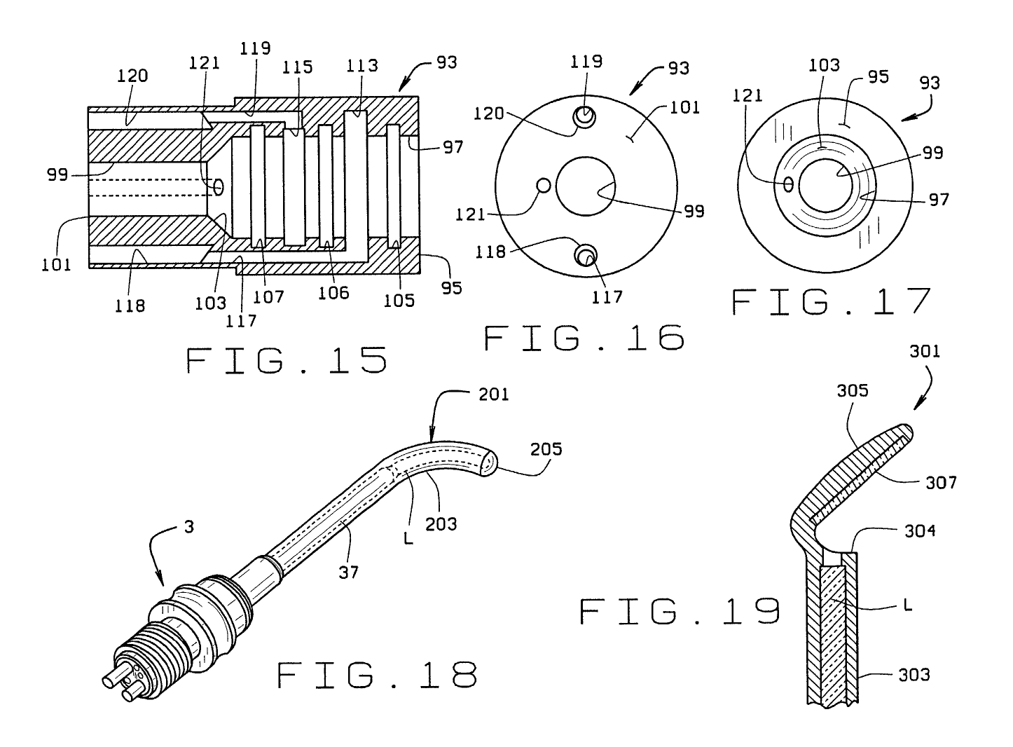

The second portion 93 of the connector (FIGS. 15-17) is fitted in the back of the tool body 81. The connector second portion 93 is sized to be force fit in the rear of the tool body 81, such that a rear surface 95 of the connector second portion 93 will be spaced forwardly (i.e., inwardly) of the rear edge 87 and the groove 85 of the tool body 81 to leave the groove 85 exposed within the tool body 81. The connector second portion 93 has a central chamber 97 (FIG. 15) which extends about ½ to ⅔ of the length of the connector second portion 93. A narrower passage 99 extends forwardly from the chamber 97 and opens into the front surface 101 of the connector second portion 93. The transition between the chamber 97 and the passage 99 is defined by a sloped or conical surface 103. The chamber 97 and passage 99 are co-axial with each other.

Three spaced apart annular channels 105, 106, and 107 are formed in the wall defining the chamber 97 to hold O-rings 109, 110, and 111 (FIG. 3). Two larger annular channels 113 and 115 are formed between the O-ring channels. That is, channel 113 is positioned between O-ring channels 105 and 106; and channel 115 is positioned between O-ring channels 106 and 107. A first axial passage 117 extends from the annular channel 113 to the front surface 101 of the connector second portion 93; and a second axial passage 119 extends from the annular channel 115 to the front surface 101 of the connector second portion 93. Lastly, a third axial passage 121 extends from the conical transition surface 103 to the front surface 101 of the connector second portion 93. The axial passages 117 and 119 are counter-bored as at 118 and 120 to receive tubes 122 and 123, respectively. (FIG. 4) The tubes 122 and 123 extend forwardly from the insert 93 to carry operating air and water, respectively to the operating end of the tool. The passage 121 is provided to deliver chip air through the tool. In as much as the operating air and water are confined in their respective tubes, a separate chip air tube is not required. However, a chip air tube could be used to carry the chip air through the tool body if desired.

The connector first portion 3 is sized to be slidingly received in the connector second portion 93 (which is fixed in the back of the tool) so that the connector second portion 93 (and hence the tool) can be rotated relative to the connector first portion 3. Thus, the connector first portion body 5 has an outer diameter slightly smaller than the inner diameter of the tool body 81; the connector first portion nose 9 has an outer diameter slightly less than the diameter of the connector second portion chamber 97; and the guide tube 37 has an outer diameter slightly less than the diameter of the connector second portion passage 99. The exits from the passages 39 and 41 are positioned on the outer surface of the connector first portion nose 9 such that they will be aligned with the channels 113 and 1 15, respectively of the connector second portion 93 when the connector first portion 3 is inserted in the connector second portion 93. The air and water passages of the connector first portion 3 will thus be in fluid communication with the air and water passages of the second portion 93, and the tubes 122 and 123. The chip air passage 43 of the connector first portion 3 empties into a chamber 124 (FIG. 4) formed when the connector portions 3 and 93 are joined. The chamber 124 is defined by the nose front surface 32 of the connector first portion 3 and the transition surface 103 in the connector second portion 93. The chip air passage 121 extends from the chamber 124 (FIG. 4) to the end of the connector second portion 93. The chip air passage of the connector first portion is thus in fluid communication with the chip air passage of the connector second portion. Thus, as can be appreciated, no matter what the relative rotational positions are between the two portions of the connector 2, the air, water, and chip air passages of the first portion 3 will always be in communication with the air, water, and chip air passages of the second portion 93.

When the connector first portion 3 is placed in the tool, the nose surface 31 will seal against the O-rings 109-111 in the connector second portion 93. The seal between the O-rings 109-111 and the connector first portion nose 9 will isolate the air and water passages from each other and from the interior of the tool body 81. Thus, the air and water will not leak out of their respective passages. The chip air, on the other hand, will pass through the tool body 81. That is, the tool body 81 itself will serve as the tube which delivers chip air to the operating end of the tool. The forwardly flowing chip air will convert the tool into a positive pressure tool. This will reduce the possibility of any contaminants being pulled into the tool body, as could happen if the tool body served as an exhaust tube which pulls or sucks exhausted operating air from the head of the tool back through the tool body.

If the tool T does not need chip air, operating air, or water, then the respective passage in the connector second portion 93 can be omitted or plugged. Alternatively, the control unit could simply be operated to prevent air and/or water from exiting the control unit.

As noted above, the air and water exit the connector first portion through the nose passages 39 and 41 which are in communication with the connector second portion channels 113 and 115, and hence with the tubes 122 and 123. The chip air exits the first connector portion nose through passage 43, which is in fluid communication with the chamber 124 and the second connector passage 121. Thus, as the tool T is rotated relative to the connector first portion 3, the connector nose passages 39, 41, and 43 will remain in fluid communication with their respective channels 117, 119, and 121 in the connector second portion 93. The light tube L is introduced into the center of the tool T, as seen in FIG. 4, and is sized to extend to the end or light output area of the tool T. For example, in a dental high-speed handpiece, the light tube will extend virtually to the head of the hand piece. The guide tube 37 is provided to give support to the light tube L and is preferably shorter than the light tube L. The light tube L is not fixed within the tool body 81. Thus, the tool body 81 can rotate relative to the light tube L, and the light tube L will not be twisted by rotation of the tool. Further, the light tube L preferably comprises optic fibers assembled in a fiber optic bundle. The fiber optic bundle is flexible, and, if it is rotated by the handpiece, the bundle will rotate within the guide tube. Thus, the optic bundle will not be subject to extreme twisting.

When the connector first portion 3 is inserted in the connector second portion 93, the lock ring 89 will snap into the groove 23 at the front of the connector first portion body 5. The flat of the lock ring 89 will hold the connector first portion 3 in place in the connector second portion 93, and hence, in the tool body 81. The lock ring 89 is sized to prevent the connector first portion 3 from being accidentally withdrawn from the connector second portion 93, and hence from the tool body 81. The connector first portion 3, however, can be easily removed by simply pulling it rearwardly out of the connector second portion 93.

Further, the connector first portion nose 9 is smooth, and the seal forming 0rings are in the connector second portion 93. If the O-rings were on the nose 9, each time a different tool were attached to the first portion 3, the O-rings would be subject to wear and tear. By having the O-rings in the second portion (and hence in the tool to be mounted to the hose) the O-rings are subject to wear and tear only when the tool is applied to the connector first portion 3. This reduces the amount of wear of the O-rings, and extends the useful life of the O-rings. Additionally, the smooth nose 9 of the first portion 3 enables the first portion 3 to be easily cleaned between uses.

As noted above, the connector first portion 3 is connected to a standard supply hose connector C to provide air, water, and/or light to an instrument. Because it includes the guide tube 37 through which the light tube L extends, the connector first portion 3 can support long handled instruments which can be controlled by the foot pedal associated with the control unit.

For example, as shown in FIG. 18, the connector first portion 3 can be used with a light probe 201 which will enable a dentist to direct light on a portion of a patient's mouth which is being examined. The attachment 201 is mounted over the guide tube 37 and light tube L. The light probe 201 includes a hollow tube 203 with a lens 205 at its end. The tube 203 is sized to be slid over the guide tube 37 and light tube L. The light tube L extends substantially to the end of the tube 203 to deliver light to the lens 205. Preferably the tube 203 is bendable and made of a material which will retain a desired shape, such as the shape shown in FIG. 18. Alternatively, the tube 203 can include a wire which will hold the tube to a desired shape. Currently, when a practitioner inspects a patient's mouth, he uses an overhead light. This light, which is bright, generally provides adequate light for inspecting the patient's mouth. However, the practitioner may block the light while he examines the patient, making it difficult for him to inspect the mouth. By mounting the light probe 201 on the connector first portion 3, the light probe is connected to the light source through the supply hose to which the connector first portion 3 is connected. The light probe 203 can then be bent as necessary to deliver light directly to the area being inspected.

In another example, a mirror attachment 301 (FIG. 19) can be used with the connector first portion 3. The mirror attachment 301 includes a hollow handle 303 sized to fit over the light tube L and the guide tube 37. The handle 303 has an open or at least a transparent front or top end 304. A head 305 extends out from the end of the handle 303 and a mirror 307 is mounted in the underside of the head. The head 305 is angled to extend over the handle 303, such that the light from the light tube 303 will exit out the end 304 of the handle 303 and reflect off the mirror 307. Currently, practitioners generally rely on the available room light or the over head light to supply light for dental mirrors when inspecting a patient's mouth with a mirror. The mirror attachment 301 will enable the practitioner to have a lighted mirror which will make it easier for him to inspect a patient's mouth with the mirror.

As various changes could be made in the above constructions without departing from the scope of the invention, it is intended that all matter contained in the above description or shown in the accompanying drawings shall be interpreted as illustrative and not in a limiting sense. For example, although not preferred, the connector first portion 3 could be adapted to be used with a tool which requires the presence of an exhaust port. The connector first portion 3 could be connected directly to the hose H. eliminating the connector C at the end of the hose. The O-rings 109-111 and O-ring channels 105-107 of the second portion chamber 97 could be replaced with circumferential ribs formed on the inner surface of the chamber 97. The connector first portion insert 51 could be integrally formed with the connector first portion body 5, such that the connector first portion would be an integral, unitary, one-piece member. These examples are merely illustrative.

1. A swivel connector for connecting a medical/dental tool to a supply hose, the supply hose being connected to sources of air, water, and light to deliver air, water, and light through the hose to the tool; the swivel connector including:
a first portion at an end of the hose; the first portion including a body having a nose extending forwardly from said body; said nose having a substantially smooth, uninterrupted outer surface and a forward end; said body including air and water passages having exits on said nose outer surface, and a light tube extending from the forward end of the nose; and
a second portion in the tool and detachably connectable to the first portion; the second portion including a chamber which receives said first portion nose; said second portion chamber having an inner surface and sealing elements on said second portion chamber inner surface, and water and air passages extending from said chamber to a front surface of said connector second portion;
wherein, when said first portion nose is inserted in said second portion chamber, said air and water passages of said first portion are placed in fluid communication with said air and water passages of said second portion, and the sealing elements in said second portion chamber seal against said first portion nose.

2. The swivel connector of claim 1 wherein said air and water passages of said connector first portion exit said first portion nose on said outer surface of said nose; said exits for said air and water passages being axially spaced from each other along said nose; and
said connector second portion includes a first annular channel and a second annular channel on said second portion chamber inner surface; said air and water passages of said second portion being in communication with said respective annular channels; said sealing elements being positioned on opposite sides of said annular channels; whereby, when said first portion nose is inserted in said second portion chamber; said exits for said first portion air and water passages are aligned with said firs and second annular channels.

3. The swivel connector of claim 1 wherein said second portion includes a passage in communication with, and extending forwardly of said chamber; said second portion passage being sized and positioned to receive said light tube from said first portion.

4. The swivel connector of claim 3 wherein said second portion includes a guide tube extending from a forward end of said second portion; said light tube passing at least partially through said guide tube.

5. The swivel connector of claim 1 wherein the swivel connector first and second portions each include chip air passages, said chip air passages being in fluid communication with each other when said first and second connector portions are connected.

6. The swivel connector of claim 5 wherein said chip air passage of said connector first portion extends through said first portion nose to exit from said end of said first portion nose; said chip air passage of said connector second portion extending from a forward surface of said chamber to a forward surface of said connector second portion; said first and second connector portions, when connected together, forming a chip air chamber defined by said first portion nose and a forward portion of said second portion chamber; said chip air passage of said first portion emptying into said chip air chamber and said chip air passage of said second portion having an opening in said chip air chamber.

7. A connector adapted to be connected to a standard connector of a supply hose of a control unit; the supply hose carrying air, water, and light from said control unit to said supply hose connector; the connector including a connector body and a nose extending from said connector body;
said connector body including an air passage operably connectable to the source of air, a water passage operably connectable to the source of water, and a light tube passage in light transmitting relationship with the source of light;
said nose having a generally smooth uninterrupted surface with an air exit in fluid communication with said body air passage, a water exit in fluid communication with said water passage, and a central passage therethrough in communication with said light tube passage; and
a light tube extending through said connector body light tube passage and said nose central passage.

8. The connector of claim 7 including a hollow guide tube extending from an end of said nose, said guide tube being axially aligned with said nose central passage, said light tube extending through said guide tube.

9. The connector of claim 8 wherein said light tube extends beyond an end of said hollow guide tube.

10. The connector of claim 7 wherein said connector body is hollow and defines a body chamber, said connector body chamber including a front wall having an air inlet in communication with said air outlet and a water inlet in communication with said water outlet; said connector including an insert received in said body chamber; said insert including said air passage, said water passage, and said light tube passage; said insert having an air outlet in communication with said nose air inlet and a water outlet in communication with said nose water inlet.

11. The connector of claim 10 wherein said light tube passage has an entrance radially off-set from a center of said connector and an exit generally centered with respect to said connector.

12. The connector of claim 4 wherein said connector includes a chip air passage in said insert and a chip air passage in said nose, said insert and nose chip air passages being in fluid communication with each other.

13. The connector of claim 12 wherein said nose chip air passage has an inlet in the wall of the body chamber and an exit at a front surface of the nose.

14. The connector of claim 8 wherein the connector receives an instrument.

15. The connector of claim 8 wherein the instrument is an inspecting probe, the probe including a sleeve sized to fit over the connector guide tube and the light tube, the sleeve having a light transparent end; the sleeve being a shape retaining sleeve made of a bendable material which can be bent to a desired angle and hold the bend.

16. The connector of claim 15 including a lens at the end of the sleeve.

17. The connector of claim 14 wherein the instrument is a mirror attachment; the mirror attachment including a hollow handle sized to fit over the guide tube and light tube and a head at the end of the handle housing a mirror; the head being angled and positioned relative to said handle to extend over the end of the handle; the handle having a light transparent end; light from said light tube passing through said handle end to impinge upon, and be reflected by, said mirror.

18. The connector of claim 14 wherein the instrument is one which uses air and water; the instrument having a back end which receives the connector; the instrument back end defining a chamber having an inner surface; said chamber inner surface having a first annular channel and a second annular channel formed thereon and sealing elements positioned on opposite sides of said annular channels; said annular channels being positioned to be aligned with the exits for said air and water passages of said connector when said connector is inserted in said instrument chamber; said sealing elements in said instrument chamber sealing against said connector nose; said instrument including an air passage which is in communication with, and extends forwardly of one of said annular channels and a water passage which is in communication with and extends forwardly from the other of said annular channels.

19. A swivel connector for connecting an instrument to a supply of air, water, and light; the swivel connector including a first portion which is rotatably received in a second portion, said second portion being located in a body of said tool;
said connector second portion including a central passage therethrough, a first annular channel formed in said central passage; a first axial passage in fluid communication with said first annular channel and extending to a forward surface of said connector second portion, a second annular channel formed in said central passage, and a second axial passage in fluid communication with said second annular channel and extending to a forward surface of said connector second portion; said central passage having a central outlet sized to admit a light tube to pass therethrough;
said connector first portion including a connector body and a nose extending from said connector body;
said connector body including an air passage operably connectable to a source of air, a water passage operably connectable to a source of water, and a light tube passage adapted to receive the light tube and to place the light tube in light transmitting relationship with a source of light;
said nose being sized to pass through said connector second portion central passage and having a generally smooth uninterrupted surface with an air exit in fluid communication with said body air passage, a water exit in fluid communication with said water passage, and a central passage therethrough in communication with said light tube passage; said air and water exits being in fluid communication with said first and second annular passages in said connector second portion when said connector first portion is received in said connector second portion; and
said light tube extending through said connector body light tube passage, said nose central passage, and said connector second portion central passage exit.

20. The swivel connector of claim 19 wherein the tool includes a body having an opened back end, an air tube extending from said connector second portion air passage outlet, and a water tube extending from said connector second portion water outlet; said air and water tubes extending through said tool body to an operating end of said tool.

21. The swivel connector of claim 19 wherein said connector second portion includes a hollow guide tube extending from an end of said nose, said guide tube being axially aligned with said nose central passage, said light tube passing through said guide tube.

22. The swivel connector of claim 21 wherein said light tube extends beyond an end of said hollow guide tube, said light tube being sufficiently long to extend substantially to tool head.

23. The swivel connector of claim 19 wherein said connector first portion includes a first O-ring groove in its said central passage on a first side of said first annular channel, a second O-ring groove in its said central passage between said first and second annular channels; and a third O-ring groove in its said central passage on a second side of said second annular passage, and O-rings received in each of said O-ring grooves; said connector first portion nose sealing against said O-rings to create fluid tight seals between said connector first portion central passage and said connector second portion nose.

24. The swivel connector of claim 19 wherein said connector first portion body is hollow and defines a connector body chamber, said connector body chamber including a front wall having an air inlet in communication with said air outlet and a water inlet in communication with said water outlet; said connector first portion including a body insert received in said body chamber; said body insert including said air passage, said water passage, and said light tube passage; said connector insert having an air outlet in communication with said nose air inlet and a water outlet in communication with said nose water inlet.

25. The swivel connector of claim 24 wherein said light tube passage has an entrance radially off-set from a center of said connector and an exit generally centered with respect to said connector.

26. The swivel connector of claim 20 wherein said connector first portion is snapped into said tool instrument body.

27. The swivel connector of claim 26 wherein said instrument body has an internal groove near a back thereof and a snap-ring received in said groove; said connector first portion body having a groove on an outer surface, said connector first portion groove adapted to receive the snap-ring to hold said connector first portion in said instrument body and in said connector second portion.

28. The swivel connector of claim 19 wherein said connector first portion includes a chip air passage and said connector second portion includes a chip air passage, said respective chip air passages of said first and second connector portions being in fluid communication with each other when said first portion is received in said second portion.

29. The swivel connector of claim 28 wherein said connector first portion chip air passage exits said connector first portion at an end of said nose; said connector nose and said connector second portion defining a chip air chamber when said connector first portion is received in said connector second portion; said chip air from said first portion body exiting into said chip air chamber, said connector second portion chip air passage having an entrance in said chip air chamber and an exit along an forward surface of said connector second portion.

30. The swivel connector of claim 29 wherein said connector second portion chip air passage exits said connector second portion at a front thereof, said tool sleeve defining a tube for said chip air to deliver the chip air to the working end of said instrument.
